(19) United States
(12) Patent Application Publication
(10) Pub. No.: US 2006/0287867 A1
(43) Pub. Date: Dec. 21, 2006

(54) Method and apparatus for generating a voice tag

(76) Inventors: Yan Ming Cheng, Inverness, IL (US); Changxue C. Ma, Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/155,944

(22) Filed: Jun. 17, 2005

(51) Int. Cl. G10L 21/00

(52) U.S. Cl. 704/275

(57) ABSTRACT

A method and apparatus for generating a voice tag (140) includes a means (110) for combining (205) a plurality of utterances (106, 107, 108) into a combined utterance (111) and a means (120) for extraction (210) of the voice tag as a sequence of phonemes having a high likelihood of representing the combined utterance, using a set of stored phonemes (115) and the combined utterance.

### FIELD OF THE INVENTION

The present invention relates generally to speech dialog systems and more particularly to speech directed information look-up.

### BACKGROUND

Methods of information retrieval and electronic device control based on an utterance of a word, a phrase, or the making of other unique sounds by a user have been available for a number of years. In handheld telephones and other handheld electronic devices, an ability to retrieve a stored information, such as a telephone number, a contact info, etc., using words, phrases, or other unique sounds (hereafter generically referred to as utterances) is very desirable in certain circumstances, such as while the user is walking or driving. As a result of the increase in computing power of handheld devices over the last several years, various methods have been developed and incorporated into handheld telephones to use an utterance to provide the retrieval of stored information.

One class of techniques for retrieving phone numbers that has been developed is a class of retrieval that uses voice tag technology. One well known speaker dependent voice tag retrieval technique that uses dynamic time warping (DTW) has been successfully implemented in a network server due to its large storage requirement. In this technique, a set of a user's reference utterances are stored, each reference utterance being stored as a series of spectral values in association with a different stored telephone number. These reference utterances are known as voice tags. When an utterance is thereafter received by the network server that is identified to the network server as being intended for the retrieval of a stored telephone number (this utterance is hereafter called a retrieval utterance), the retrieval utterance is also rendered into a series of spectral values and compared to the set of voice tags using the DTW technique, and the voice tag that compares most closely to the retrieval utterance determines which stored telephone number may be retrieved. This method is called a speaker dependent method because the voice tags are rendered by one user. This method has proven useful, but limits the number of voice tags that can be stored due to the size of each series of spectral values that represents a voice tag. The reliability of this technique has been acceptable to some users, but higher reliability would be more desirable.

Another well known speaker dependent voice tag retrieval technique also stores voice tags in association with telephone numbers, but the stored voice tags are more compactly stored in a form of Hidden Markov Model (HMM). Since this technique requires significantly less storage space, it has been successfully implemented in a handhold device, such as mobile telephone. Retrieval utterances are compared to a hidden Markov model (HMM) of the feature vectors of the voice tags. This technique generally requires more computing power, since the HMM model is generated within the handheld telephone (generating the user dependent HMM in the fixed network would typically require too much data transfer).

### BRIEF DESCRIPTION OF THE FIGURES

The accompanying figures, where like reference numerals refer to identical or functionally similar elements throughout the separate views. These, together with the detailed description below, are incorporated in and form part of the specification, and serve to further illustrate the embodiments and explain various principles and advantages, in accordance with the present invention.

FIG. 1 is a block diagram that shows an example of an electronic device that uses voice tags, in accordance with some embodiments of the present invention.

FIGS. 2 and 3 are flow charts that show some steps of methods used to generate and use voice tags, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to speech dialog aspects of electronic devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

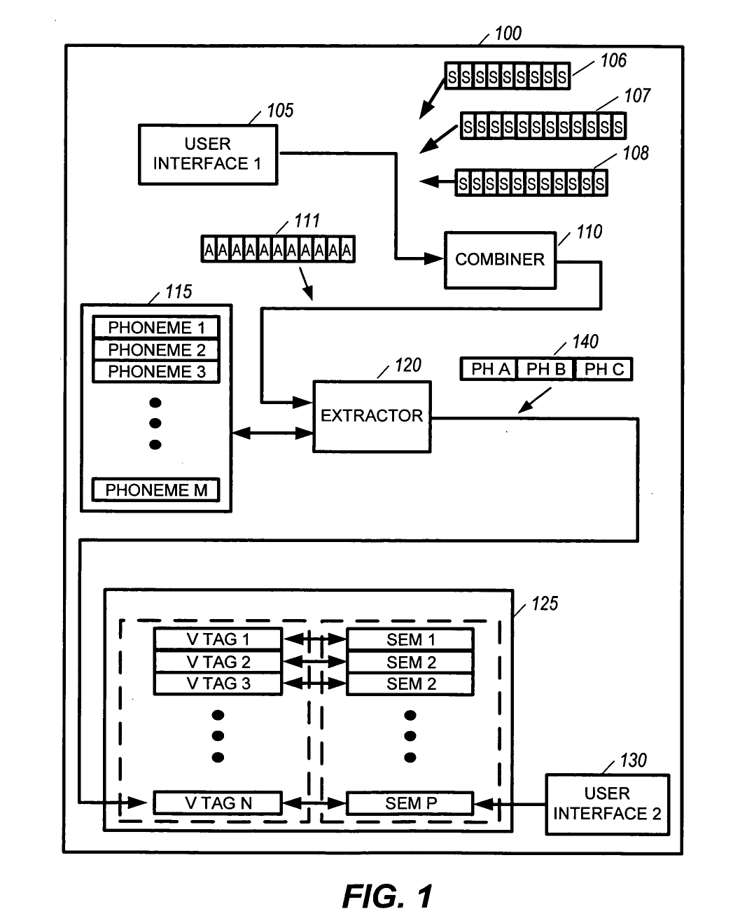

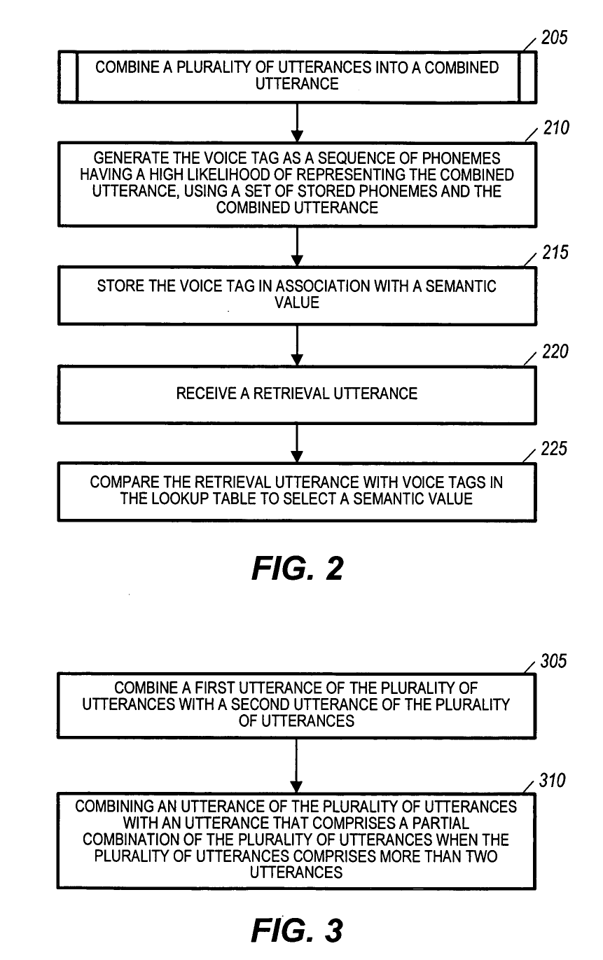

Referring to FIG. 1, a block diagram shows an example of an electronic device 100 that uses voice tags, in accordance with some embodiments of the present invention. Referring also to FIGS. 2 and 3, flow charts show some steps of methods used to generate and use voice tags, in accordance with some embodiments of the invention. The electronic device 100 (FIG. 1) comprises a first user interface 105, a combiner 110, a stored set of phonemes 115, an extractor 120, a lookup table 125, and a second user interface 130. The first user interface 105 processes utterances made by a user, converting a sound signal that forms each utterance into frames of equal duration and then analyzing each frame to generate a set of values that represents each frame, such as a vector that results from a spectral analysis of each frame. Each utterance is then represented by the sequence of vectors for the analyzed frames. In some embodiments the spectral analysis is a fast Fourier transform (FFT), which requires relatively simple computation. An alternative technique may be used, such as a cepstral analysis. The utterances, represented by the analyzed frames are coupled by the first user interface 105 to the combiner 110. The electronic device 110 may interact with the user to request the user to repeat the utterance, thus giving confidence that the utterance is for the same information. In the example shown in FIG. 1, an utterance with the same information has been repeated twice, providing three utterances as represented by sequences of spectral values 106, 107, 108. It will be appreciated that each utterance of the same information by a user may be of varying length, resulting in sequences having varying numbers of vectors. It will be further appreciated that when the frames are, for example, 20 milliseconds in duration, the number of frames in a typical utterance will typically be many more than illustrated in FIG. 1.

The utterances 106, 107, 108 may then be combined by combiner 110 into one combined utterance, which in some embodiments is a sequence of vectors of the same type as the vectors used to represent the utterances coupled to the input of the combiner 110. This act of combining utterances is shown in FIG. 2 as step 205. It will be appreciated that the combiner 110 can combine as few as two utterances, and in some cases may use only one instance of an utterance by passing the one utterance through the combiner 110 without modifying it. In the example shown in FIG. 1, the resulting utterance generated by the combiner 110 is combined utterance.

The combiner 110 may combine the plurality of utterances 106, 107, 108 by first combining two of them, as described at step 305 (FIG. 3). In the example shown in FIG. 1, where there are more than utterances to combine, the resulting utterance is termed a partially combined utterance. The partially combined utterance is then combined with another utterance as shown by step 310 (FIG. 3), using the same method used to combine the first two utterances. In the example shown in FIG. 1, step 310 is used once to generate the combined utterance 111. If more than three utterances need to be combined, then step 310 would be repeated until all the utterances were combined.

The combiner 110 performs an “averaging” operation recursively N-1 times, generating the combined utterance U as follows:
U=( . . . ((u1⊕u2)⊕u3)⊕ . . . )
wherein ⊕ designates an “averaging” operation. The “averaging” operation may be dynamic time warp (DTW) based, a technique well known in the art. The combiner 110 uses two utterances (or an utterance and a partially combined utterance) to form a trellis. One utterance forms a vertical axis and another utterance forms a horizontal axis. A dynamic programming algorithm with Euclidian distance is used to find the best alignment path of the two utterances. A new averaged utterance having a length of the best path is generated in the following way. At each point of the best path, two corresponding (or aligned) feature vectors (each from an utterance) are averaged to generate a new feature vector. This averaging operation is very light in terms of computational resource consumption compared to other alternatives, and it is very suitable to embedded platform. Other averaging techniques that combine two utterances at a time may alternatively be used, with varying effects on the quality of the combined utterance and the computational resources needed. In one example of other averaging techniques, two utterances of different length may combined at a time using linear time-warping based on the length ratio.

The combined utterance 111 generated by the combiner 110 is coupled to the extractor 120. Also coupled to the extractor 120 is a set of stored phonemes 115, which is typically a set of speaker independent phoneme models, and the set is typically are for one particular language (e.g., American English). Each phoneme in the set of phonemes may be stored in the form of sequences of values that are of the same type as the values used for the combined utterance. For the example of FIG. 1, the phonemes of these embodiments may be stored as spectral values. In some embodiments, the types of values used for the phonemes and the combined utterance may differ, such as using characteristic acoustic. vectors for the phonemes and spectral vectors for the utterances. When the types of values are different, the extractor 120 may convert one type to be the same as the other. The extractor 120 uses a speech recognition technique with a phoneme loop grammar (i.e., any phoneme is allowed to be followed any other phoneme). The speech recognition technique may use a conventional speech recognition process, and may be based on a hidden Markov model. In some embodiments of the present invention, an N-best search strategy may be used at step 210 of FIG. 2 to yield one or more alternative phonemic strings that best represent the combined utterance 111 (i.e., that have a high likelihood of correctly representing the combined utterance 111). A set of phonotactic rules may also be applied by the extractor 120 as a statistical language model to improve the performance of the speech recognition process. In the example of FIG. 1, a three phoneme sequence 140 is shown as being generated as the Mth voice tag (V TAG M) by the extractor 120. The electronic device 100 also interacts with the user through the second user interface 130 to determine a semantic value that the user wishes to associate with the voice tag(s) generated by the extractor 120. One example of the second user interface 130 is a programmed function coupled to a display and keyboard. The interaction to obtain the semantic value may occur before, during, or after the first user interface couples the utterances that are to form the voice tag(s) for the semantic value. The semantic value may be a telephone number, a picture, and address, or any information (verbal, written, visual, etc.) that the electronic device can store and that the user wishes to recall using the voice tag. In the example of FIG. 1, semantic value P (SEM P) is stored in association with voice tag N in a lookup table or other form of storage 125 that allows associations to be retained. This is an example of step 215 (FIG. 2).

When two or more voice tags are found by the extractor 120 to meet a criteria that indicates they are “best” (i.e, they have an appropriately high likelihood of correctly representing the combined utterance), the electronic device 100 stores each as a voice tag in association with the same semantic value provided by the user. As an example, voice tag 2 and voice tag 3 are stored in association with semantic value 2 in lookup table 125 (FIG. 2).

Then, as in other voice tag systems, when an utterance is received by the electronic device 100 that is identified to be for the purpose of retrieving a semantic value at step 220 (FIG. 2), the electronic device 100 analyzes the utterance, which is termed herein a retrieval utterance, to generate a representation of the retrieval utterance in the same type of values that are stored in the lookup table 125. The electronic device 100 then selects a semantic value that is associated with a voice tag that most closely compares with the retrieval utterance (and which may also have to meet a threshold criteria). This is illustrated by step 225 (FIG. 2). The electronic device 100 may then present the selected semantic to the user, or use the semantic value for a selected purpose (such as making a telephone connection).

An embodiment according to the present invention was tested that used the above described dynamic time warp averaging technique to combine three utterances two at a time, and the embodiment further used a grammar of phoneme loop to store the phoneme model of the utterance. With this embodiment, a database of 85 voice tags and semantics comprising names was generated and tested with 684 utterances from mostly differing speakers. The name recognition accuracy was 92.84%. When the voice tags for the same 85 names were generated manually by phonetic experts, the name recognition accuracy was 92.69%. The embodiments according to the present invention have an advantage over conventional systems in that voice tags related to a first language can, in many instances, be successfully generated using a set of phonemes of a second language, and still produce good accuracy.

It will be appreciated that embodiments of the invention described herein may be comprised of one or more conventional processors and unique stored program instructions that control the one or more processors to implement, in conjunction with certain non-processor circuits, some, most, or all of the functions of {replace with a technical description of the invention in a few words} described herein. The non-processor circuits may include, but are not limited to, a radio receiver, a radio transmitter, signal drivers, clock circuits, power source circuits, and user input devices. As such, these functions may be interpreted as steps of a method to perform {replace with a technical description of the invention in a few words}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method used to generate a voice tag, comprising:
combining a plurality of utterances into a combined utterance;
extracting the voice tag as a sequence of phonemes having a high likelihood of representing the combined utterance, using a set of stored phonemes and the combined utterance.

2. The method according to claim 1 in which dynamic time warping is used to combine the plurality of utterances.

3. The method according to claim 1, wherein the combining of the plurality of utterances comprises combining a first utterance of the plurality of utterances with a second utterance of the plurality of utterances.

4. The method according to claim 3, further comprising combining an utterance of the plurality of utterances with an utterance that comprises a partial combination of the plurality of utterances when the plurality of utterances comprises more than two utterances.

5. The method according to claim 1, wherein the set of stored phonemes is for a particular language.

6. The method according to claim 1, wherein the set of stored phonemes is a set of speaker independent phonemes.

7. The method according to claim 1, further comprising storing the voice tag in association with a semantic value.

8. The method according to claim 7, further comprising:
receiving a retrieval utterance; and
comparing the retrieval utterance with voice tags that have been stored, to select a semantic value.

9. The method according to claim 1, wherein the extracting of the voice tag comprises using a hidden Markov model.

10. An electronic device, comprising:
means for combining a plurality of utterances into a combined utterance;
means for extracting the voice tag as a sequence of phonemes having a high likelihood of representing the combined utterance, using a set of stored phonemes and the combined utterance, the means for extracting coupled to the means for combining.

11. The electronic device according to claim 10, further comprising a memory coupled to the means for combining that stores the set of stored phomenes.

12. The electronic device according to claim 10, further comprising a memory coupled to the means for extracting that stores each voice tag generated by the means for combining in associated with a semantic value.

13. A method for storing semantic information, comprising:
combining two utterances into a combined utterance using an averaging technique;
generating a voice tag from the combined utterance and a set of stored unitary phonemes for a language;
storing the voice tag in association with the semantic information

14. The method according to claim 13 in which dynamic time warping is used to combine the two utterances.
